(19) United States
(12) Patent Application Publication
(10) Pub. No.: US 2006/0160619 A1
(43) Pub. Date: Jul. 20, 2006

(54) Device for automatically generating a game result based on at least one weather condition

(76) Inventor: Martin Skoglund, Lerum (SE)

Correspondence Address: MANELLI DENISON & SELTER, 2000 M STREET NW SUITE 700, WASHINGTON, DC, 20036-3307, US

(21) Appl. No.: 10/539,042

(22) PCT Filed: Dec. 17, 2003
(86) PCT No.: PCT/SE03/01968

§ 371 Date: Mar. 14, 2006

(30) Foreign Application Priority Data
Dec. 18, 2002 (SE) 0203741-4

(51) Int. Cl. A63F 13/00

(52) U.S. Cl. 463/40

(57) ABSTRACT

The present invention relates to a device (1) for automatically generating a game result based on at least one weather condition at at least one geographic location at at least one predetermined point or interval in time. The device (1) comprises a processor (3), a memory (5) and communication capabilities (7). The communication capabilities (7) are connectable to a first communication means (9) associated with at least one weather parameter indication arrangement (10) which is located at the at least one location and for indicating the at least one weather condition. The communication capabilities (7) are also connectable to a second communication means (11) associated with at least one of a game computer (13) and the game result indication means (15). The processor (3) is configured for receiving at least one weather data item from the at least one weather parameter indication arrangement (10) at the at least one predetermined point in time, generating the game result by relating the at least one weather data item to a weather game type reference system (15) arranged in the memory (5); the weather game type reference system (17) defining the game; and transmitting the game result to at least one of the game computer (13) and the game result indication means (15), according to the weather game type reference system (17), for indicating the game result.

### TECHNICAL FIELD

The present invention relates to a device for automatic generating a game result based on at least one weather condition at at least one geographic location at at least one predetermined point in time.

### TECHNICAL BACKGROUND

Games and lotteries have for long time been a part of society. The advances in the field of information technology have lead to increased opportunities in the field of games. Today it is possible to game, or bet, on a wide variety of events such as sports results, president elections, and winners of music contests. Also, it is possible to bet on future weather. For instance, it may be possible to bet on cloudy weather during a weekend. Betting on weather conditions has so far been limited by the rather slow providing of the actual weather conditions to players. Also, there is a risk of players not sharing the same view of the weather condition as the organiser of the game, since the opportunities of a player to verify a weather condition communicated by the game organiser are limited. Also, the fact that the game organiser decides the weather condition related to a game may cause concern among players. This results in that there is an uncertainty as to playing games based on weather conditions.

### SUMMARY OF THE INVENTION

The purpose of the present invention is to alleviate the limitations in the art as described above. The present invention relates to a device for automatically generating a game result based on at least one weather condition at at least one geographic location at at least one predetermined point in time. The device comprises a processor, a memory and communication capabilities. The communication capabilities are connectable to a first communication means associated with at least one weather parameter indication arrangement located at the at least one location. The purpose of the weather parameter indication arrangement is to indicate the at least one weather condition. The communication capabilities are connectable to a second communication means associated with at least one of a game computer and the game result indication means. The processor is configured for receiving at least one weather data item from the at least one weather parameter indication arrangement at the at least one predetermined point or interval in time, using the first communication means. The processor is further configured for generating the game result by relating the at least one weather data item to a weather game type reference system arranged in the memory, where the weather game type reference system defines the game. Also, the processor is configured for transmitting the game result to at least one of the game computer and the game result indication means, according to the weather game type reference system, for indicating the game result. The weather data item comprises data related to a weather parameter, which is related to a weather condition. Thus, a weather condition is constituted by one or a combination of weather parameters. The game type reference system comprises information concerning one or more games. Information concerning what weather data items and what weather parameters that constitutes a game are included in the game type reference system. One advantage offered by the present invention is that the gathering and generating of the game result is highly automatic and is therefore not time consuming. Another advantage is that it is possible to play on weather conditions at a plurality of locations, when using the present invention.

In one embodiment the weather indication arrangement comprises at least one of a camera for providing a weather indicating image, a humidity sensor, a thermometer, a light intensity indicator, a rain gauge, a lightening indicator, an atmospheric pressure indicator, and a wind indicator. The various types of weather indication arrangements presented here are arranged to provide a physical output indicating the weather within the framework of a game, e.g. a light sensitivity indicator indicating a light sensitivity below a predetermined level indicates the weather condition ‘cloudy’ and a light sensitivity indicator indicating a light sensitivity exceeding a predetermined level indicates the weather condition ‘sunny’. Using a weather indication arrangement leads to a game result that is more difficult to question by players since the possibilities for a game organiser to tamper with the weather readings is made difficult. The present invention does not require that a person reads a weather indication and then communicates his/hers interpretation of that indication. Thus, the present invention alleviates the indication interpretation problem and the game organiser indication-tampering problem.

According to an embodiment, when there is a plurality of weather data items, the processor is further configured for selecting weather data items from the plurality of data weather items according to the game type reference system. This offers the advantage of opening up for dynamic games where weather data items can be used in different games.

According to an embodiment, the generating of the game result is performed in relation to the predetermined point in time. This offers the advantage of being able to communicate the game result to players shortly after the weather indication(s) constituting the game having been received by the processor.

According to an embodiment, the second communication means is constituted by the first communication means.

According to an embodiment, the first communications means is constituted by at least one of wireless and wired communication and the second communications means is constituted by at least one of wireless and wired communication.

According to an embodiment, the at least one weather parameter indication arrangement is at least one of 1) movable, 2) remotely located in relation to the device, and 3) locally located in relation the device. A weather parameter indication arrangement being movable offers the advantage that the locations of weather parameter indication arrangements may be selected more freely. This also requires updating the game type reference system. This results in a more dynamic game. A weather parameter indication arrangement that is remotely located in relation to the device offers the advantage that it is possible to include locations that are remote in the game. This also requires updating the game type reference system. This results in a more dynamic game. A weather parameter indication arrangement that is locally located in relation the device offers the advantage that it is possible to use the game locally, for instance in a city using a number of weather parameter indication arrangements in the game.

This also requires updating the game type reference system. This results in a more dynamic game. Thus, this offers the opportunity of incorporating weather conditions from a city, a country, or a continent.

According to an embodiment, the game result indication means is one of 1) remotely located in relation to the device, and 2) locally located in relation the device. This offers the advantage of being able to offer an opportunity to the game organiser to either present the game result locally or widely, for instance to present a game result in a city, a country, or a continent.

According to an embodiment, the game result indication means is constituted by at least one of a television, a computer, an information screen, a phone, a printing device and a personal digital assistant. This offers the advantage to the game organiser of having increased opportunities of allowing games to be played. In an embodiment the computer is connected to the internet.

In an embodiment, the device is incorporated in the game computer.

### A BRIEF DESCRIPTION OF THE DRAWING

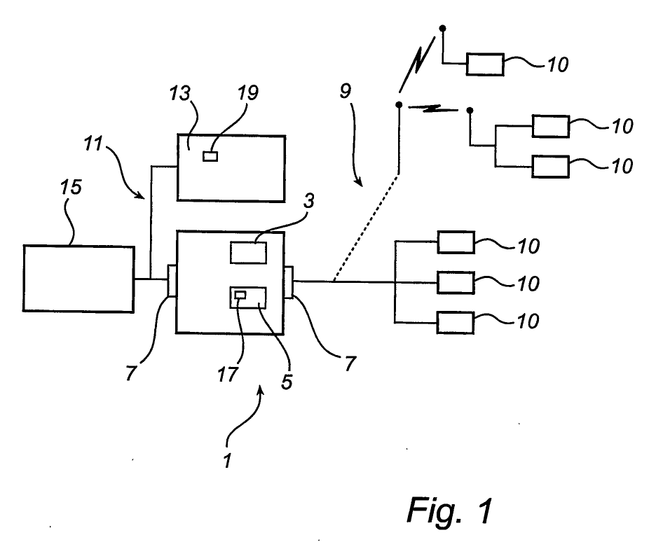

In FIG. 1 a schematic representation of the invention and its operative surroundings is presented.

### DESCRIPTION OF PREFERRED EMBODIMENTS

In FIG. 1 an embodiment of the device 1 for automatically generating a game result is presented. The game result is arranged to be based on at least one weather condition at at least one geographic location at at least one predetermined point or interval in time. The device 1 comprises a processor 3, a memory 5 and communication capabilities 7. The communication capabilities 7 are connectable to a first communication means 9 to at least one weather parameter indication arrangement 10 located at the at least one location and for indicating the at least one weather condition. The communication capabilities 7 are connectable to a second communication means 11 to at least one of a game computer 13 and the game result indication means 15.

The processor 3 is configured for receiving at least one weather data item from the at least one weather parameter indication arrangement 10 at the at least one predetermined point in time, using the first communication means 9. The data item may be transmitted in one of digital and analogous manners. After having received the at least one weather data item the processor 3 is further configured for generating the game result by relating the at least one weather data item to a weather game type reference system 17 arranged in the memory 5, where the weather game type reference system 17 defines the game. The processor 3 is further configured for transmitting the game result to at least one of the game computer 13 and the game result indication means 15, according to the weather game type reference system 17, for indicating the game result. In an embodiment, the processor 3 is also configured for storing the game result in a database located either in the memory 5 of the device 1 or in a memory 19 of the game computer 13.

In an embodiment, when there is a plurality of weather data items, the processor 3 is further configured for selecting weather data items from the plurality of data weather items according to the game type reference system 17. This selecting feature of the device 1 is central when the device 1 is responsible for handling a plurality of games in the weather game type reference system 17. In an embodiment the generating of the game result is performed in relation to the predetermined point in time. In an embodiment the second communication means 11 is constituted by the first communication means 9. In an embodiment the first communications means 9 is constituted by at least one of wireless and wired communication and the second communications means 11 is constituted by at least one of wireless and wired communication. In an embodiment the weather parameter indication arrangement 10 comprises at least one of a camera for providing a weather indicating image, a humidity sensor, a thermometer, a light intensity indicator, a rain gauge, a lightening indicator, an atmospheric pressure indicator, and a wind indicator. In an embodiment, the at least one weather parameter indication arrangement 10 is at least one of movable, remotely located in relation to the device 1, and locally located in relation the device 1. In an embodiment, the game result indication means 15 is one of remotely located in relation to the device 1, and locally located in relation the device 1. In an embodiment, the game result indication means 15 is constituted by at least one of a television, a computer, which may be associated with the internet, an information screen, a phone, a printing device and a personal digital assistant. In an embodiment, the device 1 is incorporated in the game computer 13. In general, the weather parameter indication arrangements 10 are arranged to output indications of present weather parameters covering specific weather conditions. The processor 3 is arranged to receive weather data items originating from the weather parameter indication arrangement 10.

The weather parameter indication arrangements 10 are arranged for interpreting their readings by dividing them into a predetermined set of alternatives. Alternatively the interpretation may instead be arranged to be done by the processor 3 by comparing the received data items to a comparative index related to weather parameters. In the table below, weather parameter indication arrangements 10 and non limiting examples of their output spectrum are presented.

| Weather parameter | Non limiting examples of their output |
|---|---|
| indication arr. | spectrum |
| A humidity sensor | < H₁ % =>‘Dry at sampling time’ |
| | > H₁ % and < H₂ % => ‘Humid at |
| | sampling time’ |
| | > H₂ % => ‘Rain at sampling time’ |
| A thermometer | < T₁ => ‘Below T₁ at sampling time’ |
| | > T₁ => ‘Above T₁ at sampling time’ |
| | T (the temperature measurement itself) |
| A light intensity | < X₁ => ‘Dark at sampling time’ |
| indicator | > X₁ and < X₂ => ‘Cloudy at sampling |
| | time’ |
| | > X₂ => ‘Sunny at sampling time’ |
| A rain gauge | < Z₁ mm => ‘No rain during time |
| | interval’ |
| | > Z₁ mm => ‘Rainy during time |
| | interval’ |
| | Z (the rain measured in e.g. mm) |
| | ‘Yes’ or ‘No’ |
| A lightening | < N₁ => ‘Limited lightening’ |
| indicator | > N₁ => ‘Lightening’ |
| | Numbers of flashes/lightening |
| An atmospheric | < P₁ => ‘Below P₁ at sampling time’ |
| pressure indicator | > P₁ => ‘Above P₁ at sampling time’ |
| A wind indicator | < W₁ => ‘Not windy at sampling time |
| | > W₁ => ‘Windy at sampling time’ |
| | > W₂ => ‘Very windy at sampling time’ |
| | W (the wind indication itself) |

From the table it is clear that the output spectrum can comprise both a logic output (e.g. ‘Dry at sampling time’) and a number indicating the corresponding weather condition parameter (e.g. the temperature).

By combining weather parameter indication arrangements 10, their locations and the points or time interval, it is possible to support to a high number of games.

In an illustrative embodiment, the weather parameter indication arrangement 10 is constituted by a light intensity indicator and the weather game type reference system 17 arranged with the following characteristics.

< 5 W/m² => ‘Cloudy’
Between 5 and 120 W/m² => ‘Semi
cloudy and semi sunny’
> 120 W/m² => ‘Sunny’

Assuming that the locations are London, Cairo, and Paris, at which locations weather parameters indicator arrangements 10, in this example light sensitivity indicators, are arranged. The time is set to 12.00 CET. The device is located in Berlin. Thus the three indicators 10 are remotely arranged. The operation of the device 1 according to this embodiment is as follows. The device 1 will prompt the light sensitivity indicators and there from receive shortly after 1200 CET weather data items comprising numbers of Watts per square meter from the three indicators 10, using the first communication means 9. Assuming that the readings from the indicators 10 are, London: 3, Cairo: 112, and Paris 130, then the device 1 would generate the following game result.

London: ‘Cloudy’
Cairo: ‘Semi cloudy and
semi sunny’
Paris: ‘Sunny’

Also in this embodiment, there are cameras in the three cities for providing a weather indicating image. The images are also transmitted using the first communication means 9 to the device 1. After having generated the game result it is transmitted to a game computer 13 and a game result indication means 15, using the second communication means 11. In this case the game result indication means 15 is constituted by a television via a television broadcast network.

In another illustrative embodiment, there are three weather parameter indication arrangements 10: A thermometer, a wind indicator, and a humidity sensor. In this embodiment the weather game type reference system 17 is as follows.

| Weather | |
|---|---|
| condition | Output spectrum |
| Temperature | < 20 degree Centrigrade => ‘Warm’ |
| | > 20 degrees Centrigrade => ‘Cold’ |
| Wind | < 1 m/s => ‘No wind’ |
| | > 1 m/s => ‘Windy’ |
| Humidity | < 40% => ‘Dry during sampling time’ |
| | > 80% => ‘Rain during sampling time’ |

The sampling time is an interval starting at 11.00 and ending at 12.00. The three weather parameter indication arrangements 10 at the same location provide the following readings to the device 1 using the first communication means 10: Temperature: 18 degrees Centigrade, Wind: 3 m/s, and Humidity: 100%. The game result, as generated by the device 1, is ‘Cold’, ‘Windy’, and ‘Rain’. The game result is transmitted to a game computer 13, which is arranged to keep track of game related information, such as odds and game turnover. The game result is also transmitted to a game result indication means 15 in the form of a presentation screen for providing information concerning the game result.

1. Device (1) for automatically generating a game result based on at least one weather condition at at least one geographic location at at least one predetermined point or interval in time, the device (1) comprising a processor (3), a memory (5) and communication capabilities (7),
the communication capabilities (7) being connectable to a first communication means (9) associated with at least one weather parameter indication arrangement (10) located at the at least one location and for indicating the at least one weather condition;
the communication capabilities (7) being connectable to a second communication means (11) associated with at least one of a game computer (13) and the game result indication means (15);
the processor (3) being configured for
receiving at least one weather data item from the at least one weather parameter indication arrangement (10) at the at least one predetermined point in time, using the first communication means (9);
generating the game result by relating the at least one weather data item to a weather game type reference system (15) arranged in the memory (5); the weather game type reference system (17) defining the game; and
transmitting the game result to at least one of the game computer (13) and the game result indication means (15), according to the weather game type reference system (17), for indicating the game result.

2. Device according to claim 1, wherein, when there is a plurality of weather data items, the processor (3) is further configured for
selecting weather data items from the plurality of data weather items according to the game type reference system (17).

3. Device according to claim 1, wherein the generating of the game result is performed in relation to the predetermined point in time.

4. Device according to claim 1, wherein the second communication means (11) is constituted by the first communication means (9).

5. Device according to claim 1, wherein the first communication means (9) is constituted by at least one of wireless and wired communication and the second communication means (11) is constituted by at least one of wireless and wired communication.

6. Device according to claim 1, wherein the weather parameter indication arrangement (10) comprises at least one of a camera for providing a weather indicating image, a humidity sensor, a thermometer, a light intensity indicator, a rain gauge, a lightening indicator, an atmospheric pressure indicator, and a wind indicator.

7. Device according to claim 1, wherein the at least one weather parameter indication arrangement (10) is at least one of:
movable;
remotely located in relation to the device (1); and
locally located in relation the device (1).

8. Device according to claim 1, wherein the game result indication means (15) is one of
remotely located in relation to the device (1); and
locally located in relation the device (1).

9. Device according to claim 1, wherein the game result indication means (15) is constituted by at least one of a television, a computer, an information screen, a phone, a printing device and a personal digital assistant.

10. Device according to claim 1, wherein the device (1) is incorporated in the game computer (13).
